(19) United States
(12) Patent Application Publication
(10) Pub. No.: US 2004/0058734 A1
(43) Pub. Date: Mar. 25, 2004

(54) Flexible rotational drive coupling device

(76) Inventor: Trevor Grey Williams, Lilburn, GA (US)

Correspondence Address: TREVOR WILLIAMS C/O OMNI INTERNATIONAL, 1800 SANDY PLAINS INDUS PKWY, SUITE 118, MARIETTA, GA, 30066, US

(21) Appl. No.: 10/253,796

(22) Filed: Sep. 24, 2002

(51) Int. Cl. F16D 3/78

(52) U.S. Cl. 464/89

(57) ABSTRACT

Disclosed is a torque transmitting flexible coupling assembly. The flexible coupling is designed to transfer torque from an input to an output without transferring bending stress between. Friction and or interlocking cross sectional shapes transmits the torque and can be adjusted to allow slippage before overloading and damaging any driving motor.

### BACKGROUND OF THE INVENTION

Mechanical shear homogenizers (or dispersers) generally consist of a generator probe and a motor that drives the generator probe. The function of the generator probe is to homogenize different media by means of a high speed rotating rotor stator assembly. When coupling and connecting the generator probe to the motor unit, a method to absorb the misalignment between the motor and probe is required to alleviate bending stress transmitted through the assembly in turn putting unacceptable loads on the bearings. A number of complex devices have been designed to eliminate the transmitted bending loads between motor and probe. Although these coupling or drive connect methods are effective and reliable, their high construction costs make them unacceptable for inexpensive or economy-oriented generator probes. In some inexpensive homogenizing units, a standard metal compressive collet is utilized to connect the motor drive shaft directly and rigidly to the probe drive shaft. This design does not compensate for motor to probe misalignment and therefore transmits radial loads through the drive shaft. The transmitted bending stress puts load on the bearings radially to unacceptable levels. A flexible coupling is needed to mitigate transmitted bending stress due to misalignment.

Another drawback of rigidly mounting the drive shaft to the motor with a collet is that the axial, angular, and concentricity run-out of all the drive components is additive. This stacking of manufacturing imperfections causes the homogenizer drive shaft to vibrate, wobble, and rotate off-axis from its ‘nominal’ or ‘basic’ location; this puts intense dynamic loads on the bearings and causes premature failure, unacceptable vibrations, and component friction heating. Further problems exist because the drive shaft is connected to, or integrated with, a rotor knife that resides at the lower end of the shaft. The drive shaft with included rotor and bearing are assembled inside a stator tube that requires small clearances to the rotor for favorable homogenizing performance. Anticipation of misalignment requires increased clearance between the rotor and stator to prevent metal-to-metal contact. This increase in clearance decreases homogenizing performance. A flexible coupling is needed in the assembly to increase probe efficiency and reduce probe vibration and heating.

Most laboratory homogenizers can be stand mounted and left unattended to allow the homogenizing process to proceed without constant user attention. If the target sample of homogenizing were to clog or stop the rotor shaft, the resulting increase in torque demand will overload the driving motor. Current safety regulations require the homogenizer be protected from catching fire if the unit were to become clogged or stopped during operation. Currently, a thermal fuse is used to shut off the unit if the motor becomes too hot indicating an extreme increase in required torque due to a homogenizer lock-up. A collet derived flexible coupling which incorporates a maximum permissible torque feature would simplify the protective measures needed by allowing the motor to continue turning at a safe torque demand while the drive shaft is in a lock-up.

### FIELD OF THE INVENTION

This invention relates to torque-transmitting devices, specifically to medical or laboratory rotary instruments where a simple and inexpensive way of driving a small rigid shaft rotary tool is needed while compensating for any angular misalignment between the shaft components thus eliminating vibration and transmitted bending stress.

### SUMMARY OF THE INVENTION

The present invention is a flexible rotational drive coupling device consisting of four main parts. This device includes an output shaft, input shaft, an elastic compressing ring (referred to as a flexible coupling during description), and an adjusting compressing fitting (referred to as a coupling nut during description). The present coupling device can receive or transmit torque from either side of the assembly, so either of the two shafts can be used for either purpose. That is, this text will illustrate an input shaft and an output shaft, but the device can be used in reverse therefore using the dictated input shaft as the output shaft.

The present invention utilizes frictional force between shaft components to transmit torsion through the system. A flexible coupling made of an elastomeric material resides between the assembly input and the assembly output. This flexible coupling possesses a frictional resistance to slippage against the input and output shafts. The flexible coupling's frictional component is dictated by a compressive force applied to it from the coupling nut. Therefore the amount of permissible transmitted torque can be adjusted by the amount of compression on the flexible coupling. The material of the flex coupling, input shaft, and output shaft also has a large effect on the maximum transmittable torque through the system. Materials interfacing with higher coefficient of friction will describe a higher torque limit. Cross-sectional geometry of the output shaft can also have a large effect on maximum transmittable torque. In a slightly different embodiment, the cross section of the input shaft can be a shape other than a conventional circle (cylindrical shaft) therefore interlocking the output shaft and the flexible coupling together; this design intent could also be realized by bonding or otherwise affixing the flexible coupling to the output shaft. This embodiment transfers torque primarily using the flexible coupling's resistance to detrimental deformation instead of using friction, so while the flex coupling deforms enough to eliminate transmitted bending stress through the assembly, it resists the deformation required to allow output shaft slippage. Maximum torque capability can be adjusted by changing the amount of compression applied to the flexible coupling by the coupling nut.

The flexible coupling is the only point of contact between the input and output shafts. This allows the input and output shafts to move independently of each other. The freedom of motion between parts absorbs and eliminates any bending stress attempting to transmit from input to output.

### BRIEF DESCRIPTION OF THE DRAWINGS

FIG. 1. Exploded isometric view of the flexible rotational drive-coupling device unassembled.

FIG. 2. View of flexible rotational drive coupling device showing the flex coupling uncompressed.

FIG. 3. Sectional view taken along line 3-3 of FIG. 2.

FIG. 4. View of the flexible rotational drive coupling device showing the flex coupling compressed by the coupling nut.

FIG. 5. Sectional view taken along line 5-5 of FIG. 4.

FIG. 6. End view of the flexible coupling of FIG. 7, along view lines 6-6.

### DETAILED DESCRIPTION OF THE INVENTION

The present invention is a flexible rotational drive coupling device 12 composed of four main parts. Two of the parts are cylindrical output 8 and input 11 shafts entering or exiting the device. The tubular shaped elastic compressing ring 10 (referred to as a flexible coupling 10 during description) is formed of an elastomeric material and is responsible for transmitting all torque while absorbing misalignments and resulting bending stresses. The adjusting compressing fitting (referred to as a coupling nut 9 during description) compresses the flexible coupling 10 against both the shafts 8 and 11. The flexible rotational coupling device 12 can receive or transmit torque from either side of the assembly, so either of the two shafts can be used for input or output. That is, this text will illustrate an input shaft 11 and an output shaft 8, but the device can be used in reverse therefore using the dictated input shaft 11 as the output shaft.

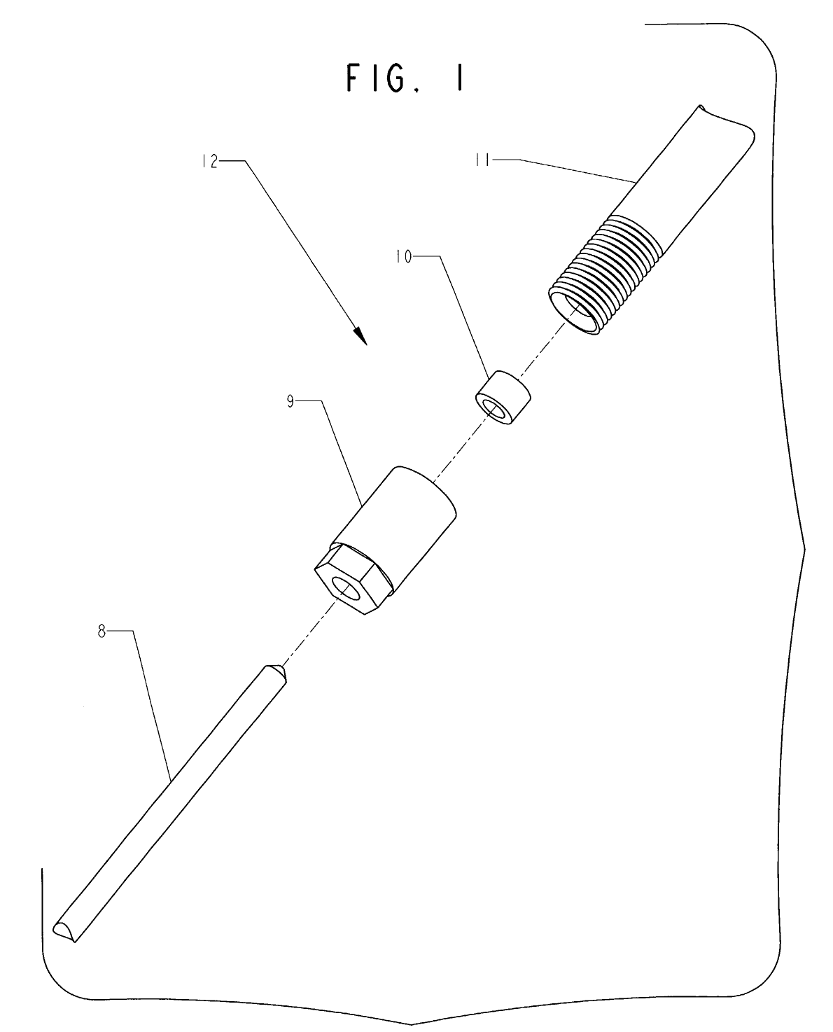

Referring to FIG. 1, the input shaft 11 consists of a cylindrical rod with external threads. The external threads are to mate with the coupling nut 9 during the assembly of this device. The input shaft 11 also must be hollow or have a hole bored coaxially into one face of the shaft. This hole can be bored to a particular depth to assist in axially locating the output shaft 8, or it may be of irrelevant depth with the output shaft 8 axial location depending on other assembly factors. The interior diameter is constant, but the axial face through which the inner hole passes should be tapered in a convex fashion. The degree of this taper can range between 10 and 90 degrees from the axis of the shaft, but this angle can vary depending on required performance specification needs of the drive coupling device.

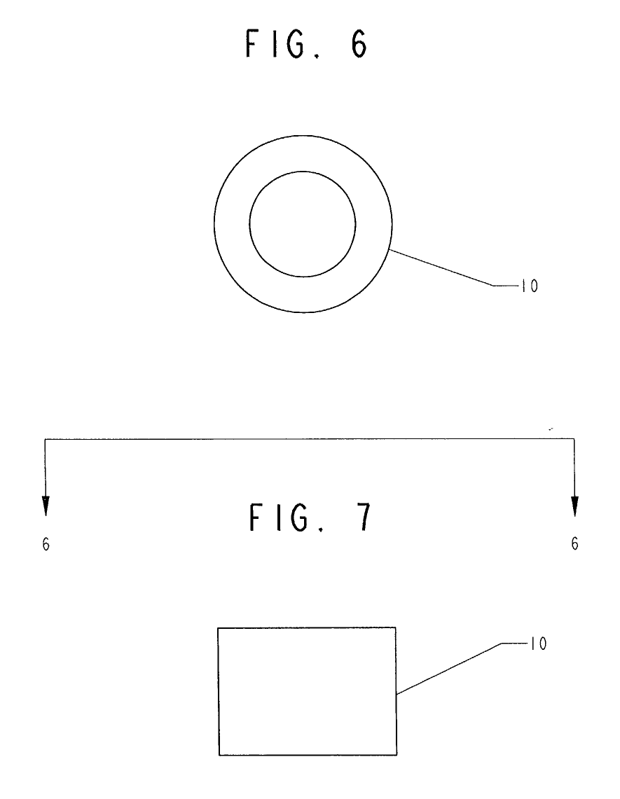

The flex coupling 10, as best shown in FIGS. 6 and 7, is a hollow cylinder constructed of an elastomeric material. The design of this could be most easily described as a short length of rubber tubing. The construction elastomer can be a material such as rubber, vinyl, PVC, latex, Viton™, or any other similar material that posses a durometer appropriate to the particular assembly. A Durometer of approximately Shore A 60 was found to provide ideal compression and friction characteristics. The flex coupling 10 exterior diameter should be no larger than the input shaft 11 exterior diameter, and the interior diameter of the flex coupling 10 should fit snugly onto the output shaft 8 diameter. The length of the flex coupling 10 is not important; a length equaling the its cylindrical diameter is sufficient, but longer lengths can increase maximum transmittable torque. The ends of the flex coupling 10 can be chamfered to mate more securely with the input shaft 11 and coupling nut 9 tapers.

The output shaft 8 is of a smaller diameter than the input shaft 11. The output shaft 8 is small enough to fit inside the hollow portion of the input shaft 11 as dictated by FIG. 3. The maximum angular misalignment possible by this assembly is mostly determined by the amount of clearance between the output shaft 8 and the inside bore of the input shaft 11. The dimensions of the output shaft 8 exterior diameter, input shaft 11 exterior diameter, and input shaft coaxial hole are determined by torque requirements and material constraints. The only important relative dimension is the interior diameter of the input shaft compared to the exterior dimension of the output shaft. The amount of clearance between these two parts will influence the amount of axial misalignment capable of this device.

In a slightly different embodiment, the output shaft 8 can be a shape other than a cylindrical shaft. Cross-sectional geometry of the output shaft 8 can have a large effect on maximum transmittable torque. When a non-circular cross section shaft is used, the flexible coupling 10 should possess a mating shape as the definition of its axial hole that accepts the input shaft. For instance, if the output shaft possessed an extruded square shape, then the flexible coupling will be a cylindrical shape on the outside with a square co-axial hole through the inside therefore mating with the output shaft. Whereas the primary embodiment transfers torque from flexible coupling 10 to output shaft 8 primarily by friction, this embodiment transfers torque from flexible coupling 10 to output shaft 8 primarily by the flexible coupling's 10 resistance to detrimental deformation. Maximum permissible torque of this embodiment may increase with cross sections possessing sharp angles (triangle, star, square, torx™). The torque limit will also increase with a flexible coupling 10 constructed of a higher durometer elastomer. In this embodiment, as in the primary, torque is transmitted between the input shaft 11 and the flexible coupling 10 by friction; further, a slippage mode at maximum torque can be overcoming input shaft 11 and flexible coupling 10 friction or deformation of the flexible coupling 10 by the output shaft 8 to the point of relative rotational motion between the two. The coupling nut 9 is still used in this embodiment to adjust the maximum amount of permissible torque of the assembly. This embodiment can also be realized with a flexible coupling 10 bonded or integral with the output shaft 8; this embodiment's primary slippage mode at maximum torque would be between input shaft 11 and flexible coupling 10 due to overcoming friction between the two.

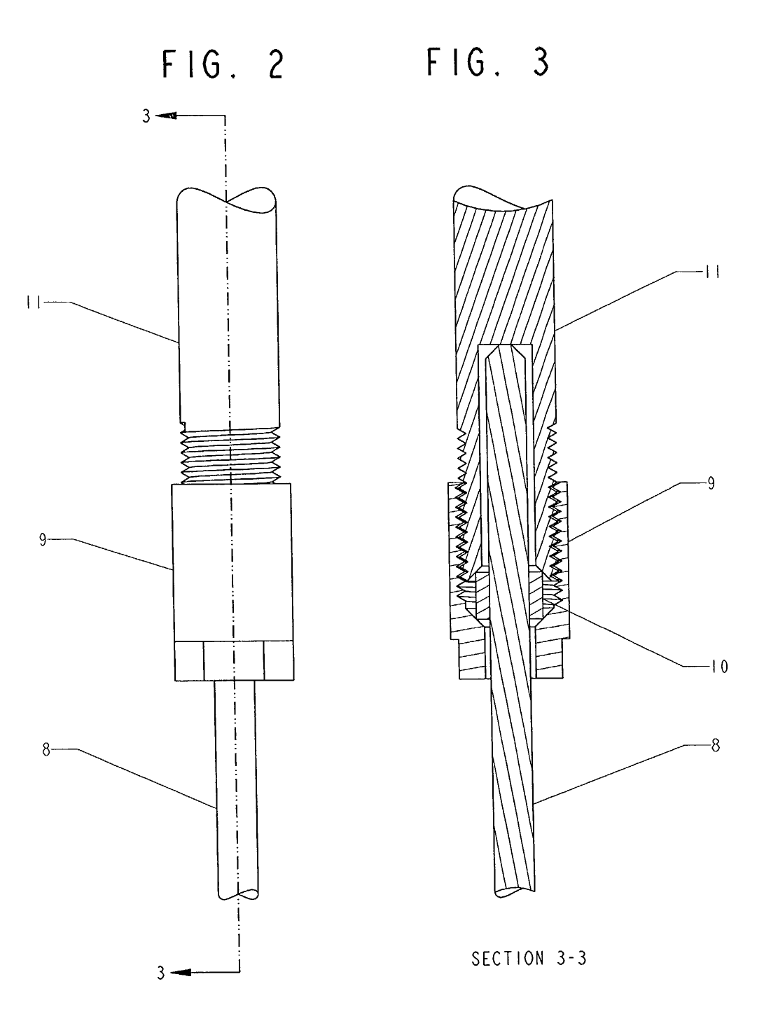

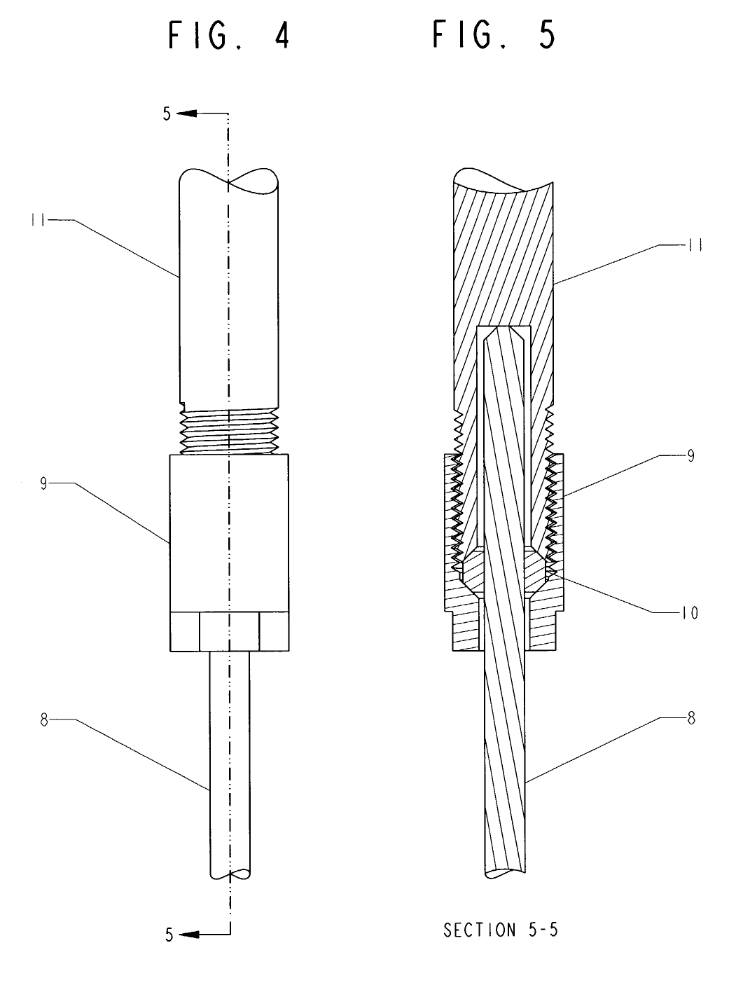

The coupling nut 9 is a mating part for the input shaft 11. The external shape of the coupling nut 9 is unimportant, although a cylindrical shape with flats for affixing a tool would be ideal. The external shape shown in FIGS. 1-5 is cylindrical with a hexagonal shape cut to allow for a wrench interface. The internal threads of the coupling nut 9 screw onto external threads of the input shaft 11. The threads stop at a conical taper on the inside of the coupling nut as seen in FIGS. 3 and 5. This taper is of a concave manner and can range between 10 and 90 degrees from the part's cylindrical axis. Modifying the taper can alter the physical performance of the flexible rotational coupling device. The coupling nut 9 must have a through hole that allows the output shaft 8 to pass completely through the coupling nut 9.

Upon assembly of the present invention, the flexible coupling 10 is slid over the output shaft 8. Then the output shaft 8 is slid into the input shaft's 11 hollow portion until the flexible coupling 10 rests against the concave taper of the input shaft 11. Then the coupling nut 9 is slid over the output shaft 8 and threaded onto the input shaft 11. As the coupling nut 9 is tightened onto the input shaft 11, the internal concave taper of the coupling nut and the concave taper on the end of the input shaft squeeze the flexible coupling 10. The compression force on the elastomer transmits to compression on the output shaft 8 therefore putting a significant amount of normal force on the elastomer-to-metal contact regions. The normal force of the elastomer-to-metal contact when calculated with the material characteristics of the elastomer will determine the maximum amount of torque deliverable by the assembly. This maximum torque is dependent on the friction between the flexible coupling 10 and its metal contact points.

The amount of friction between the flexible coupling 10 and contacted drive components can be changed by threading the coupling nut 9 less or more onto the input shaft 11. The maximum amount of friction is also influenced by the taper angle of the input and output shafts (11 and 8).

We claim:

1. A torque transmitting coupling assembly comprising of an input shaft with a coaxial hole, an output shaft, an adjusting compressing fitting, and an elastic compression ring to transmit torsion force using an adjustable friction component.

2. The assembly of claim 1 wherein the elastic coupling compensates and absorbs angular misalignment between components protecting the bearings and eliminating vibration by prohibiting transmitted bending stress between input and output.

3. The assembly of claim 1 wherein the elastic compression ring may be composed simply of a hollow cylindrical elastomer which is compressed with adjustable amounts of force against two faces thus adjusting the maximum amount of torque transmittable to the output shaft.

4. The assembly of claim 1 wherein the compression ring may interlock with the input or output shaft by means of mating cross-sectional shapes or by direct bonding.

5. The assembly of claim 1 wherein the friction between parts is adjusted to limit torque before overheating the driving motor thus satisfying safety requirements for powered systems.

6. The assembly in claim 1 wherein the parts are of a simple construction utilizing inexpensive material, such as rubber tubing, reducing cost of the device.
